(19) United States
(12) Patent Application Publication
(10) Pub. No.: US 2015/0044550 A1
(43) Pub. Date: Feb. 12, 2015

(54) SULFUR CATHODE FOR LITHIUM-SULFUR BATTERY

(71) Applicant: Hyundai Motor Company, Seoul (KR)

(72) Inventors: Sang Jin PARK, Bucheon-si (KR); Hee Yeon RYU, Yongin-si (KR); Dong Hui KIM, Suwon-si (KR)

(73) Assignee: Hyundai Motor Company, Seoul (KR)

(21) Appl. No.: 14/089,524

(22) Filed: Nov. 25, 2013

(30) Foreign Application Priority Data
Aug. 7, 2013 (KR) 10-2013-0093706

(51) Int. Cl. H01M 4/62; H01M 4/04

(52) U.S. Cl. CPC H01M 4/622; H01M 4/0416
USPC 429/188; 429/218.1; 429/217; 427/58; 427/122

(57) ABSTRACT

A lithium-sulfur battery uses different binders that exhibit different swelling ratios in an electrolyte as cathode binders and thus having superior cycle performance and battery capacity. A first binder is a binder having a large swelling ratio in an electrolyte, and a second binder is a binder having a small swelling ratio in the electrolyte. The first binder is in direct contact with the active material. The second binder may indirectly contact the active material as being present between a plurality of first binders which are in direct contact with the active material.

### CROSS-REFERENCE TO RELATED APPLICATIONS

This application claims the benefit of priority under 35 U.S.C. §119 to Korean Patent Application No. 10-2013-0093706, filed on Aug. 7, 2013, in the Korean Intellectual Property Office, the disclosure of which is incorporated herein by reference in its entirety.

### TECHNICAL FIELD

The present disclosure relates to a lithium-sulfur battery using different binders that exhibit different swelling ratios in an electrolyte as cathode binders, and thus having superior cycle performance and battery capacity.

### BACKGROUND

The lithium-sulfur battery has a remarkably high energy density (theoretically energy density=2,600 Wh/kg) as compared to the existing lithium-ion battery (theoretical energy density=570 Wh/kg, currently available energy density=−120 Wh/kg). However, upon repeated charging and discharging, the cathode structure is disrupted as the sulfur in the cathode is dissolved out into the electrolyte in the form of polysulfide (Li₂Sₓ). This results in decreased cycle performance of the battery. Accordingly, the role of the binder that maintains the cathode structure is very important to ensure good capacity and cycle characteristics of the lithium-sulfur battery.

The existing techniques relating to the binder of a lithium-sulfur battery are as follows.

Japanese Patent Application Publication No. 2002-050405 discloses a polymer electrolyte cell having improved ion conductivity and storage property in a solvent (swelling ratio), which includes a positive electrode. A positive electrode mixture layer containing an active material and a binder polymer is laminated on a current collector and a negative electrode, wherein a negative electrode mixture layer containing an active material and a binder polymer is laminated on a current collector. The binder polymers contained in the positive electrode mixture layer and the negative electrode mixture layer are different polymers having different swelling ratios.

Japanese Patent Application Publication No. 2008-047402 discloses a nonaqueous electrolyte secondary battery which can prevent leakage of an electrolyte solution and has improved current load characteristics. Wherein a polymer having a low solvent swelling ratio is used in an electrode mixture layer, and a polymer having a high solvent swelling ratio is used in an electrode part.

Korean Patent Application Publication No. 2004-0037154 discloses a nonaqueous electrolyte secondary battery comprising positive and negative electrodes both containing a material that stores and releases lithium ions and a binder polymer, one or more separators for separating the electrodes from each other, and a nonaqueous electrolyte containing a lithium salt and an organic solvent.

Korean Patent Application Publication No. 2008-0081297 discloses a lithium-ion capacitor comprising a positive electrode containing a positive electrode active material which can be reversibly doped with lithium ions and/or anions. A negative electrode contains a negative electrode active material which can be reversibly doped with lithium ions and an aprotic organic solvent electrolyte solution of a lithium salt as an electrolyte.

The present disclosure is novel and different from the previously disclosed techniques and allows high discharge capacity and stability by using a mixture of binders having high and low swelling ratios in an electrolyte for a sulfur cathode of a lithium-sulfur battery.

Throughout the specification, a number of publications and patent documents are referred to and cited. The disclosure of the cited publications and patent documents is incorporated herein by reference in its entirety to more clearly describe the state of the related art and the present disclosure.

### SUMMARY

The present disclosure provides a cathode binder material to solve the problem of decreased lifetime of a lithium-sulfur battery owing to dissolution of sulfur into an electrolyte during repeated charge-discharge cycles and disruption of a cathode structure resulting therefrom.

In an aspect of the present disclosure, a lithium-sulfur battery uses sulfur as a cathode active material. A first binder is a binder having a large swelling ratio in an electrolyte, and a second binder is a binder having a small swelling ratio in the electrolyte. The first binder is in direct contact with the active material. The second binder may indirectly contact the active material as being present between a plurality of first binders which are in direct contact with the active material.

The electrolyte may be selected from ethylene carbonate (EC), propylene carbonate (PC), dimethyl carbonate (DMC), di-ethyl carbonate (DEC), ethyl methyl carbonate (EMC), di-methoxy ethane (DME), c-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof. The first binder has the swelling ratio of 30-100% in the selected electrolyte, and the second binder has the swelling ratio of 0-50% in the selected electrolyte.

In another aspect of the present disclosure, a method for preparing a cathode for a lithium-sulfur battery includes preparing a first slurry by mixing sulfur with a conducting material, a first binder, and a solvent and drying the first slurry (at 40-110° C.). A second slurry is prepared by mixing the dried product with a conducting material, a second binder and a solvent and coated on an electrode plate. An electrolyte of the lithium-sulfur battery is selected from ethylene carbonate (EC), propylene carbonate (PC), dimethyl carbonate (DMC), di-ethyl carbonate (DEC), ethyl methyl carbonate (EMC), di-methoxy ethane (DME), c-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof. The first binder has a swelling ratio of 30-100% in the selected electrolyte and the second binder has a swelling ratio of 0-50% in the selected electrolyte.

The dried first slurry may be pulverized and then mixed with the conducting material, the second binder, and the solvent to prepare the second slurry.

In another aspect of the present disclosure, a method for preparing a cathode for a lithium-sulfur battery includes preparing a first slurry by mixing sulfur with a conducting material, a first binder, and a solvent. The first slurry is dried under drying condition and pulverized, and the pulverized product is dispersed in a solvent. A second slurry is prepared by mixing the dispersed product with the conducting material, a second binder, and the solvent and coated on an electrode plate. An electrolyte of the lithium-sulfur battery is selected from ethylene carbonate (EC), propylene carbonate (PC), dimethyl carbonate (DMC), di-ethyl carbonate (DEC), ethyl methyl carbonate (EMC), di-methoxy ethane (DME), c-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof. The first binder has a swelling ratio of 30-100% in the selected electrolyte and the second binder has a swelling ratio of 0-50% in the selected electrolyte.

The first binder having high ion conductivity provides high conductivity and the second binder allows maintenance of the cathode structure even after repeated charge-discharge cycles because its binding ability is not decreased.

Other features and aspects of the present disclosure will be apparent from the following detailed description, drawings and claims.

### BRIEF DESCRIPTION OF THE DRAWINGS

The above and other objects, features, and advantages of the present disclosure will now be described in detail with reference to certain exemplary embodiments thereof illustrated in the accompanying drawings which are given hereinbelow by way of illustration only, and thus is not limitative of the disclosure.

FIG. 1 schematically shows a cathode active material prepared according to the present disclosure using a first binder and a second binder.

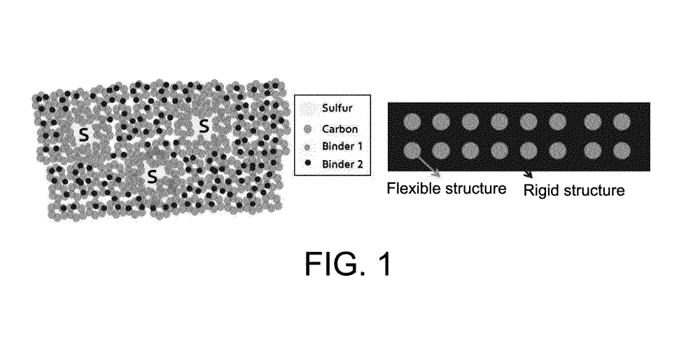

FIG. 2 is a graph showing a specific capacity vs. voltage for three samples prepared according to the present disclosure using a first binder and a second binder.

FIG. 3 is a graph showing a specific capacity vs. number of cycle for three samples prepared according to the present disclosure using a first binder and a second binder.

### DETAILED DESCRIPTION

Hereinafter, reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents, and other embodiments, which may be included within the spirit and scope of the disclosure as defined by the appended claims.

The present disclosure provides a lithium-sulfur battery using sulfur as a cathode active material, wherein a first binder is a binder having a large swelling ratio in an electrolyte, and a second binder is a binder having a small swelling ratio in the electrolyte. The first binder is in direct contact with the active material. Whereas, the second binder indirectly contacts the active material as being present between a plurality of first binders which are in direct contact with the active material.

The binder of a lithium-sulfur battery may be roughly divided into two categories. A binder having a large swelling ratio in an electrolyte increases ion conductivity since the binder uptakes the electrolyte, and as a result, resistance decreases during charging and discharging, and improves discharge capacity and discharge voltage because of flexible structure and large conducting area available for reaction. However, the binding ability of the binder decreases due to the uptake of the electrolyte, and cycle performance decreases after repeated charge-discharge cycles owing to disruption of the cathode structure.

In contrast, a binder having a small swelling ratio in an electrolyte is advantageous in that it exhibits constant cycle performance even after repeated charge-discharge cycles because the binding ability of the binder is not decreased. However the binder having a small swelling ratio in an electrolyte has large electrochemical resistance, and both initial discharge capacity and voltage are low owing to rigid structure and small conducting area available for reaction.

Therefore, the present disclosure provides a novel cathode for a lithium-sulfur battery including different (a first and a second) binders having different swelling ratios in an electrolyte.

The binder having a large swelling ratio in the electrolyte is used as the first binder which is in contact with the active material sulfur so as to provide a flexible structure. The binder having a small swelling ratio in the electrolyte is used as the second binder which directly contacts the active material as being present between a plurality of first binders which are in direct contact with the active material so as to provide a rigid structure. The resulting cathode exhibits high flat band voltage, high discharge capacity, and stable cycle performance during discharging.

The electrolyte of the lithium-sulfur battery may be selected from a group consisting of ethylene carbonate (EC), propylene carbonate (PC), dimethyl carbonate (DMC), di-ethyl carbonate (DEC), ethyl methyl carbonate (EMC), di-methoxy ethane (DME), c-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof. The first binder may have the swelling ratio of 30-100% in the selected electrolyte, and the second binder may have the swelling ratio of 0-50% in the selected electrolyte. The swelling ratios of the first binder and the second binder may partially overlap to include the swelling ratio of 30-50% for good cell performance in general.

The first binder may be one or more selected from a group consisting of polyvinyl acetate, polyvinyl alcohol, polyethylene oxide, polyvinylpyrrolidone, polystyrene, polyvinyl ether, poly(methyl methacrylate), polyvinylidene fluoride, polyhexafluoropropylene-polyvinylidene fluoride copolymer, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof. Since the first binder and the second binder differ not in their identities but in their swelling ratios in the electrolyte, they may be different binders selected from the same materials.

The second binder may be one or more selected from a group consisting of polyvinyl acetate, polyvinyl alcohol, polyethylene oxide, polyvinylpyrrolidone, polystyrene, polyvinyl ether, poly(methyl methacrylate), polyvinylidene fluoride, polyhexafluoropropylene-polyvinylidene fluoride copolymer, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

The cathode of the lithium-sulfur battery may include 40-85 wt % of the active material, 10-50 wt % of a conducting material, 2-25 wt % of the first binder, and 3-25 wt % of the second binder.

The conducting material may be one or more selected from a group consisting of graphite, Super C (commercially available from Timcal), vapor grown carbon fiber (VGCF), Ketjen black, Denka black, acetylene black, carbon black, carbon nanotube, multi-walled carbon nanotube, and ordered mesoporous carbon.

The present disclosure also provides a method for preparing a cathode for a lithium-sulfur battery, steps including:

a. preparing a first slurry by mixing sulfur with the conducting material, the first binder and the solvent.

b. drying the first slurry at 40-110° C. and pulverizing.

c. preparing a second slurry by mixing the pulverized product of the step b with the conducting material, the second binder, and the solvent.

d. coating the second slurry on an electrode plate.

An electrolyte of the lithium-sulfur battery is selected from EC, PC, DMC, DEC, EMC, DME, GBL, THF, DOL, DEE, MF, MP, DMSO, TEGDME, derivatives thereof, and mixtures thereof. The first binder has a swelling ratio of 30-100% in the selected electrolyte, and the second binder has a swelling ratio of 0-50% in the selected electrolyte.

The pulverization in the step b may be omitted.

In the step c, the pulverized product, the conducting material and the second binder may not be mixed at once, but the pulverized product may be first dispersed in the solvent. The pulverized product has a surface polarity similar to that of the first binder since the first binder surrounds the sulfur and the conducting material. Since the polarity of the solvent for the second binder may be entirely different from that of the solvent for the first binder, although they may be equal, it may be difficult to disperse the pulverized product in the solvent. Accordingly, by sufficiently dispersing the pulverized product, which is the most difficult to disperse, in the solvent, it is possible to prepare a more uniform electrode.

### Example

The present disclosure will be described in more detail through an example. The following example is for illustrative purposes only and it will be apparent to those skilled in the art not that the scope of this disclosure is not limited by the example.

Samples 1-3 were prepared as described in Table 1, according to a procedure including:

a. preparing a first slurry by mixing sulfur with a conducting material, a first binder, and a solvent.

b. drying the first slurry at 40-110° C.

c. preparing a second slurry by mixing the dried product with the conducting material, a second binder, and the solvent.

d. coating the second slurry on an electrode plate.

TABLE 1

| | | | First binder | |
|---|---|---|---|---|
| | Sulfur | Conducting | PVDF-HFP | Second binder |
| | size | material | copolymer | PVDF |
| Sample # | ≦5 μm | VGCF | (M_{w} = 450,000) | (M_{w} = 1100,000) |
| 1 | 60% | 20% | 0% | 20% |
| 2 | 60% | 20% | 20% | 0% |
| 3 | 60% | 20% | 10% | 10% |

The sample 3 exhibited higher discharge capacity and flat band voltage than the sample 1 during discharging. Also, the sample 3 exhibited superior cycle performance as compared to that of the sample 2.

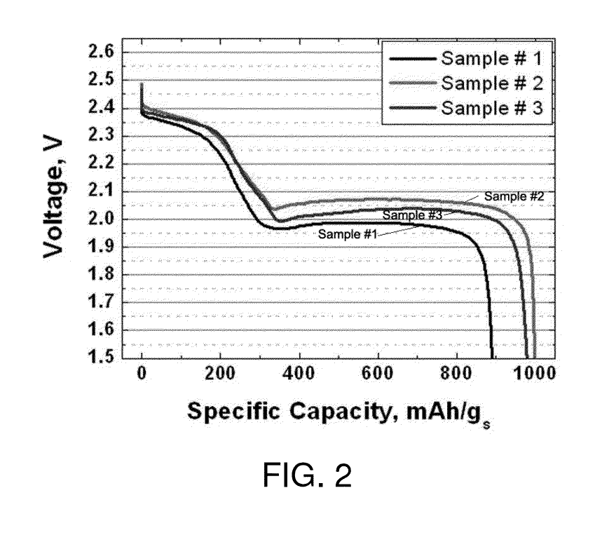

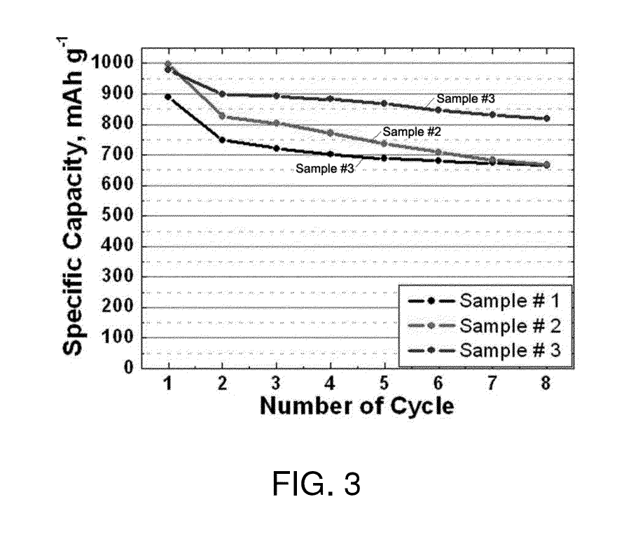

Referring to FIGS. 2 and 3, both the discharge capacity and the cycle performance can be improved by using two binders having different swelling ratios in an electrolyte.

The present disclosure has been described in detail with reference to specific embodiments thereof. However, it will be appreciated by those skilled in the art that various changes and modifications may be made in these embodiments without departing from the principles and spirit of the disclosure, the scope of which is defined in the appended claims and their equivalents.

1-19. (canceled)

20. A lithium-sulfur battery using sulfur as a cathode active material comprising:
a first binder having a large swelling ratio in an electrolyte;
a second binder having a small swelling ratio in the electrolyte, wherein
the first binder is in direct contact with the active material, and
the second binder indirectly contacts the active material as being present between a plurality of first binders which are in direct contact with the active material.

21. The lithium-sulfur battery according to claim 20, wherein the first binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

22. The lithium-sulfur battery according to claim 20, wherein the second binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

23. The lithium-sulfur battery according to claim 20, wherein the electrolyte is selected from a group consisting of ethylene carbonate (EC), propylene carbonate (PC), dimethyl carbonate (DMC), di-ethyl carbonate (DEC), ethyl methyl carbonate (EMC), di-methoxy ethane (DME), γ-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof, wherein the first binder has the swelling ratio of 30-100% in the selected electrolyte, and the second binder has the swelling ratio of 0-50% in the selected electrolyte.

24. The lithium-sulfur battery according to claim 20, wherein a cathode of the lithium-sulfur battery comprises 40-85 wt % of the active material, 10-50 wt % of a conducting material, 2-25 wt % of the first binder, and 3-25 wt % of the second binder.

25. The lithium-sulfur battery according to claim 24, wherein the conducting material is one or more selected from a group consisting of graphite, Super C (commercially available from Timcal), vapor grown carbon fiber, Ketjen black, Denka black, acetylene black, carbon black, carbon nanotube, multi-walled carbon nanotube, and ordered mesoporous carbon.

26. A method for preparing a cathode for a lithium-sulfur battery, comprising:
a. preparing a first slurry by mixing sulfur with a conducting material, a first binder, and a solvent;
b. drying the first slurry at 40-110° C. and pulverizing the same;
c. preparing a second slurry by mixing the pulverized product with the conducting material, a second binder, and the solvent; and
d. coating the second slurry on an electrode plate,
wherein an electrolyte of the lithium-sulfur battery is selected from a group consisting of ethylene carbonate (EC), propylene carbonate (PC), dimethyl carbonate (DMC), di-ethyl carbonate (DEC), ethyl methyl carbonate (EMC), di-methoxy ethane (DME), γ-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof, wherein the first binder has a swelling ratio of 30-100% in the selected electrolyte, and the second binder has a swelling ratio of 0-50% in the selected electrolyte.

27. A method for preparing a cathode for a lithium-sulfur battery, comprising:
a. preparing a first slurry by mixing sulfur with a conducting material, a first binder, and a solvent;
b. drying the first slurry at 40-110° C.;
c. preparing a second slurry by mixing the dried product with the conducting material, a second binder, and the solvent; and
d. coating the second slurry on an electrode plate,
wherein an electrolyte of the lithium-sulfur battery is selected from a group consisting of ethylene carbonate (EC), propylene carbonate (PC), dimethyl carbonate (DMC), di-ethyl carbonate (DEC), ethyl methyl carbonate (EMC), di-methoxy ethane (DME), γ-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof, wherein the first binder has a swelling ratio of 30-100% in the selected electrolyte, and the second binder has a swelling ratio of 0-50% in the selected electrolyte.

28. A method for preparing a cathode for a lithium-sulfur battery, comprising:
a. preparing a first slurry by mixing sulfur with a conducting material, a first binder, and a solvent;
b. drying the first slurry under drying condition and pulverizing;
c. dispersing the pulverized product in the solvent.
d. preparing a second slurry by mixing the dispersed product with the conducting material, a second binder, and the solvent; and
e. coating the second slurry on an electrode plate,
wherein an electrolyte of the lithium-sulfur battery is selected from a group consisting of ethylene carbonate (EC), propylene carbonate (PC), dimethyl carbonate (DMC), di-ethyl carbonate (DEC), ethyl methyl carbonate (EMC), di-methoxy ethane (DME), γ-butyrolactone (GBL), tetrahydrofuran (THF), dioxolane (DOL), diethoxyethane (DEE), methyl formate (MF), methyl propionate (MP), dimethyl sulfoxide (DMSO), tetraethylene glycol dimethyl ether (TEGDME), derivatives thereof, and mixtures thereof, wherein the first binder has a swelling ratio of 30-100% in the selected electrolyte, and the second binder has a swelling ratio of 0-50% in the selected electrolyte.

29. The method according to claim 26, wherein the conducting material is one or more selected from a group consisting of graphite, Super C (commercially available from Timcal), vapor grown carbon fiber, Ketjen black, Denka black, acetylene black, carbon black, carbon nanotube, multi-walled carbon nanotube, and ordered mesoporous carbon.

30. The method according to claim 26, wherein the first binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

31. The method according to claim 26, wherein the second binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

32. The method according to claim 27, wherein the conducting material is one or more selected from a group consisting of graphite, Super C (commercially available from Timcal), vapor grown carbon fiber, Ketjen black, Denka black, acetylene black, carbon black, carbon nanotube, multi-walled carbon nanotube, and ordered mesoporous carbon.

33. The method according to claim 28, wherein the conducting material is one or more selected from a group consisting of graphite, Super C (commercially available from Timcal), vapor grown carbon fiber, Ketjen black, Denka black, acetylene black, carbon black, carbon nanotube, multi-walled carbon nanotube, and ordered mesoporous carbon.

34. The method according to claim 27, wherein the first binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

35. The method according to claims 28, wherein the first binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

36. The method according to claim 27, wherein the second binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.

37. The method according to claim 28, wherein the second binder is one or more selected from a group consisting of polyvinyl acetate, polyethylene oxide, polyvinylpyrrolidone, polyvinyl ether, polyvinyl alcohol, poly(methyl methacrylate), polyvinylidene fluoride, polyhexafluoropropylene-polyvinylidene fluoride copolymer, polystyrene, poly(ethyl acrylate), polytetrafluoroethylene, polyvinyl chloride, polyacrylonitrile, carboxymethyl cellulose (CMC), styrene-butadiene rubber (SBR), derivatives thereof, blends thereof, and polymers thereof.
